(19) United States
(12) Patent Application Publication
(10) Pub. No.: US 2005/0288422 A1
(43) Pub. Date: Dec. 29, 2005

(54) Rubber compositions of enhanced flame resistance, articles formed therefrom and related method

(76) Inventors: John Burns, Simpsonville, SC (US); Kim Van Voorhis, Rutherfordton, NC (US); George Hairston, Spartanburg, SC (US); Warren Stidham, Cohutta, GA (US)

Correspondence Address: JAMES M. ROBERTSON, 233 SOUTH PINE STREET, SPARTANBURG, SC, 29302, US

(21) Appl. No.: 10/992,128

(22) Filed: Nov. 18, 2004

Related U.S. Application Data
(60) Provisional application No. 60/523,472, filed on Nov. 19, 2003.

(51) Int. Cl. C08K 5/02

(52) U.S. Cl. 524/469

(57) ABSTRACT

A rubber composition including at least one base rubber intermixed with a non-brominated intumescent flame retardant composition. The rubber composition is characterized by enhanced flame resistance.

### CROSS-REFERENCE TO RELATED APPLICATIONS

This application claims the benefit of and priority from U.S. provisional application 60/523,472 filed Nov. 19, 2003, the contents of which are incorporated by reference herein in their entirety.

### TECHNICAL FIELD

This invention relates generally to rubber such as dry rubber compounds and articles formed therefrom which incorporate a non-brominated flame retardant additive of intumescent character to provide enhanced resistance to flammability.

### BACKGROUND OF THE INVENTION

Dry rubbers are well known and are used in a number of environments to provide a strong, durable yet resilient material. In a number of environments where rubbers are used it may also be desirable to have a degree of flammability resistance. By way of example only, such environments may include automotive and aeronautic applications, appliances, building materials and the like.

In the past, in order to enhance flame resistance, rubber has often been treated by addition of brominated flame retardants. The use of brominated materials such as decobromodiphenyl oxide and polybrominated diphenyl ethers (PBDEs) has been particularly common in such applications. While such materials have provided generally good levels of flame retardancy, it is now believed that such materials may give rise to undesirable health problems in some users.

### SUMMARY OF THE INVENTION

The present invention provides advantages and alternatives over the prior art by providing dry rubbers which incorporate an intumescent flame retardant composition of non-brominated character as well as a method of producing such rubbers. The flame retardant composition may be blended directly into the rubber mixture during compounding such as at a Banbury mixer or the like. Additional additives may also be incorporated.

### DESCRIPTION OF PREFERRED EMBODIMENTS

While the present invention has been generally described above and will hereinafter be described in conjunction with certain potentially preferred embodiments procedures, and practices, it is to be understood that in no case is the invention to be limited to such described embodiments, procedures, and practices. On the contrary, it is intended that the present invention shall extend to all alternatives, modifications, and equivalents as may embrace the principles of the present invention within the true scope and spirit thereof.

According to a potentially preferred practice, the flame retardant composition is of a so called “intumescent” character which is characterized by undergoing a swelling and charring when exposed to substantial heat. By way of example only, and not limitation, the flame retardant composition preferably contains (i) a blowing agent such as melamine, urea, dicyandiamide or combinations thereof; (ii) an acid donor such as ammonium polyphosphate, mono-ammonium phosphate, diammonium phosphate, potassium tripolyphosphate or combinations thereof; (iii) a carbon donor such as dipentaerythritol (DPE), pentaerythritol, polyol, or a combinations thereof; and (iv) a chlorinated paraffin wax.

According to one potentially preferred practice the flame retardant composition will contain about 0 to 90 percent by weight melamine, more preferably about 10 to 80 percent melamine and most preferably about 40 percent by weight melamine. The flame retardant composition will preferably contain about 0 to 90 percent by weight ammonium polyphosphate, more preferably about 5 to 40 percent by weight ammonium polyphosphate and most preferably about 20 percent by weight ammonium polyphosphate. The flame retardant composition will preferably contain about 0 to 90 percent by weight chlorinated paraffin wax, more preferably about 5 to 40 percent by weight chlorinated paraffin wax and most preferably about 20 percent by weight chlorinated paraffin wax. By way of example only, one such chlorinated paraffin wax which is believed to be suitable is marketed under the trade designation CHLOROWAX 70 from Dover Chemical in Dover Ohio. The flame retardant composition will preferably contain about 0 to 90 percent by weight pentaerythritol, more preferably about 5 to 40 percent by weight pentaerythritol and most preferably about 20 percent by weight pentaerythritol. Of course, all such percentages are exemplary only and may be varied as desired.

In practice it is contemplated that the flame retardant composition may be intermixed directly with a natural or synthetic base rubber such as natural rubber, nitrile, neoprene, acrylonitrile, vinyl pyridene, vinylidine chloride polybutadiene, styrene acrylic, isoprene, ethylene vinyl chloride, EPDM, block copolymers and blends thereof as well as co-polymers, ter-polymers and the like of suitable monomers as may be known to those of skill in the art along with any other additives as may be desired. It is contemplated that the weight percentage of the flame retardant composition relative to the dry rubber may vary widely depending on the rubber properties and flame resistance desired. However, in general it is believed that the flame retardant composition will preferably be present at a level of about 10% to about 200% by weight of the dry rubber content. Of course, it is contemplated that such levels may be readily adjusted as desired thereby providing substantial flexibility in the process.

As indicated, it is contemplated that a number of other additives may also be added to the blend to impart desired physical properties. By way of example only, such additional additives may include vulcanizing agents, fillers, plasticizers, antioxidants, pigments, blowing agents and the like as will be known to those of skill in the art of rubber compounding. The resulting compound may thereafter be cured and used in a number of applications.

The present invention may be further understood by reference to the following non limiting example.

### EXAMPLE

A contemplated exemplary formula for a dry rubber compound of enhanced flame resistance is as follows:

| CONSITUENT | Parts By Weight |
|---|---|
| Base Rubbber (SBR) | 100 |
| Flame retardant composition | 100 |
| Carbon Black | 15 |
| Sulfur | 1.8 |
| Zinc Oxide | 2.0 |
| Zinc Mercapto Butyl Thalate | 1.0 |
| Zinc Diethyl Dithio Carbamate | 1.0 |
| Antioxidant (Wingstay L) | 1.0 |
| Wax-Microcrystalline | 5.0 |

It has been found that such rubbers provide flame resistance at levels comparable to those of prior rubbers including brominated compounds despite the absence of such compounds. Accordingly, it is believed that the present invention provides substantial advantages over the prior art.

It will be appreciated that the flame retardant rubbers of the present invention may find application in an almost unlimited array of uses. By way of example only, various end uses may include automotive and aeronautic applications including tires, seals, gaskets and the like, as well as appliances, construction materials and other environments where rubber is presently used.

While the present invention has been described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. A rubber composition comprising at least one base rubber intermixed with a non-brominated intumescent flame retardant composition such that rubber composition is characterized by enhanced flame resistance.

2. The invention as recited in claim 1, wherein the flame retardant composition comprises an acid donor, a carbon donor and a blowing agent.

3. The invention as recited in claim 1, wherein the flame retardant composition comprises an acid donor, a carbon donor and a blowing agent and a chlorinated paraffin wax.

4. A rubber composition comprising at least one base rubber intermixed with a non-brominated intumescent flame retardant composition such that rubber composition is characterized by enhanced flame resistance, wherein the base rubber is NBR and wherein the flame retardant composition comprises an acid donor, a carbon donor and a blowing agent.

5. A rubber composition comprising at least one base rubber intermixed with a non-brominated intumescent flame retardant composition such that rubber composition is characterized by enhanced flame resistance, wherein the base rubber is SBR and wherein the flame retardant composition comprises an acid donor, a carbon donor and a blowing agent.
